(19) United States
(12) Patent Application Publication
(10) Pub. No.: US 2024/0426099 A1
(43) Pub. Date: Dec. 26, 2024

(54) FIRE RETARDANT BREATHER MEMBRANE

(71) Applicants: DUPONT DE NEMOURS (LUXEMBOURG) SARL, Luxembourg (LU); SPECIALTY ELECTRONIC MATERIALS NETHERLANDS B.V., Dordrecht (NL); Lenzing Plastics GmbH & Co KG, Lenzing (AT)

(72) Inventors: GUZEL AFANASYEVA, LUXEMBOURG (LU); NORBERT FREY, LUXEMBOURG (LU); ROB RASENBERG, DORDRECHT (NL); HUBERT GRIESHOFER, WALDWEG (AT)

(21) Appl. No.: 18/679,963

(22) Filed: May 31, 2024

Related U.S. Application Data
(60) Provisional application No. 63/505,167, filed on May 31, 2023.

(51) Int. Cl. E04B 1/94; B32B 5/02; B32B 7/12; B32B 27/12; B32B 27/40; E04B 1/66

(52) U.S. Cl. CPC E04B 1/948; B32B 5/024; B32B 7/12; B32B 27/12; B32B 27/40; E04B 1/665; B32B 2250/02; B32B 2262/101; B32B 2307/3065; B32B 2307/718; B32B 2419/00

(57) ABSTRACT

A fire-retardant membrane comprising a base sheet comprising glass fiber having a basis weight of 296 to 420 grams per square meter and a maximum organic content of 1.5 weight percent; and a thermoplastic elastomer film attached to the base sheet, the film having a basis weight of 20 to 35 grams per square meter; wherein the thermoplastic elastomer film is attached to the base sheet by use of an adhesive being discontinuously present between the film and the sheet at an areal density of 25 to 40% and an amount of from 4 to 6 grams per square meter; and wherein the fire-retardant membrane has a Gross Heat of Combustion (PCS) of less than 3 MJ/kg and less than 4 MJ/sqm as measured per EN ISO 1716.

### BACKGROUND OF THE INVENTION

### Field of the Invention

This invention relates to sheet structure suitable for use in buildings and construction, specifically sheet structures that are fire retardant, resistant to the passage of liquid water, but will pass moisture vapor; and are suitable for use as a façade product on buildings. The sheet structures are particularly useful in buildings having open façades using spacers, where the sheet structure can be exposed to the environment.

### Description of Related Art

Recently, high profile building fires like the 24-storey Grenfell Tower fire in West London have focused attention on improved fire-retardant building cladding materials. While that fire started on a lower floor, it spread rapidly up the building's exterior to all residential floors and was accelerated by dangerously combustible cladding and external insulation, with an air gap between them enabling the stack effect.

This type of construction can include an outer decorative cladding that is mounted on the outer sheathing material of the building, and in some instances the mounting includes spacers that mount the cladding with an air gap between the cladding and the outer sheathing material of the building. In some instances, it is desirable to have a vapor-permeable but water resistant layer between the cladding and the outer sheathing material to provide improved energy efficiency to the building. Typically, this vapor-permeable but water resistant layer is mounted on the surface of the outer sheathing material and is referred to as a “breather membrane” or a water-resistant barrier (WRB).

The development of adequately noncombustible breather membranes having high permanent water resistance and moisture vapor permeability has been challenging. The sheet structures currently used as breather membranes in these types of façade applications have significant negative attributes.

One such sheet structure is a heavy three-layer structure of glass fiber surfaced with a microporous polymer layer and an outer face of perforated aluminum; the aluminum being perforated to achieve the desired breathability of the sheet structure. This sheet structure can meet many of the breathability and water resistance requirements, and even the Euroclass A2 Fire Class requirement. However, the use of a microporous membrane is undesirable because the water holdout performance can be affected by surfactants that can lower the surface contact angles, allowing water penetration through the micropores; meaning the water holdout performance is not permanent. Additionally, the manufacture of the sheet structure requires the combining, assembling, and attaching together of three different types of layers to each other; and the associated complexities and costs involved are not desirable.

A two-layer sheet structure, therefore, would be simpler and more desirable, and one such sheet structure is a layer of glass fiber having a continuously-coated surface of an extruded silicon, polyurethane, or acrylic polymer. However, this material has either low breathability or limited ability to prevent water intrusion. Intuitively, the ability to reduce water intrusion could be improved by providing a thicker coating; however, this would in turn further reduce the breathability or moisture vapor transport, or compromise reaction to fire due to an increase in PCS value.

Therefore, there is increased pressure in the industry for higher fire requirements, and stricter regulations are anticipated; and noncombustible, breathable, and watertight membranes for façade applications are needed. Particularly needed is a breather membrane having a two-layer structure and the desired combination of vapor permeability, liquid water resistance, and non-combustibility properties. In particular, a breather membrane is needed that can meet what is called the “trinity” of properties at a high performance level, that “trinity” of properties being the combination of adequate breathability (a Sd value <0.12 meters); water resistance (W1 class), and non-combustibility (Fire Class A2).

### BRIEF SUMMARY OF THE INVENTION

This invention relates to a fire-retardant membrane comprising a base sheet comprising glass fiber, the base sheet having a basis weight of 296 to 420 grams per square meter, the base sheet having a maximum organic content of 1.5 weight percent; and a thermoplastic elastomer film attached to the base sheet, the film having a basis weight of 20 to 35 grams per square meter; wherein the thermoplastic elastomer film is attached to the base sheet by use of an adhesive, the adhesive being discontinuously present between the film and the sheet at an areal density of 25 to 40% and the adhesive is present in an amount of from 4 to 6 grams per square meter; and wherein the fire-retardant membrane has a Gross Heat of Combustion (PCS) of less than 3 MJ/kg and less than 4 MJ/sqm as measured per EN ISO 1716.

### DETAILED DESCRIPTION OF THE INVENTION

This invention relates to a fire-retardant breather membrane that is a two-layer structure having the desired trinity of properties; the breather membrane can be combined with fire-retardant tape to provide a light and non-combustible shield in or on the facades of buildings.

The calorific value is the amount of energy that is produced by the complete combustion of a material. This amount of energy determines how much heat a certain material contributes to a fire. More heat simply means a faster spreading of the fire. The calorific content of a panel is indicated by its PCS (abbreviation of the French term ‘Pouvoir Calorifique Supérieur’) value. The higher a PCS value is, the more calorific content a panel has; that is, the more it contributes to a fire.

In the European Union, EN13501-1 provides a classification of fire classes, called the Euroclass system, with the class designations ranging from the most stringent Classes A1 & A2 to Classes B, C, D, E, & F. The classes reflect a gradation of non-combustibility wherein classes A1 and A2 are non-combustible and classes B-F combustible. When you use non-combustible materials, you basically design out the fire risk, because this material does not significantly contribute to a fire. The non-combustibility ratings of A1 and A2 reflect set limits to the calorific content (PCS values) of the materials. For combustible materials (B-F) these limits are not set. Non-combustible facade material (Euroclass A1 & A2) has a very low calorific value, and thus a very low contribution to the fire, with Euroclass A1 having a lower PCS limit than Euroclass A2.

The breather membrane comprises a base sheet comprising glass fiber and a thermoplastic elastomer film attached to the base sheet with an adhesive. In particular, the breather membrane is a combination of a glass fiber fabric having very low organic content with very thin layer of thermoplastic polyurethane (TPU) monolithic film, assembled together with a low amount polyurethane adhesive that does not sacrifice vapor breathability for liquid holdout. The breather membrane meets the requirement for a Euroclass A2 fire class rating.

The base sheet comprising glass fiber is preferably a plain weave glass fabric, and in some embodiments the base sheet comprises E-glass. In some embodiments, the base sheet is a E/ECR (E-Glass Corrosion Resistant) glass mat having a plain weave with leno weft threads. It is believed a base sheet comprising ceramic or silica glass could be used as long as it meets the organic content requirements.

The base sheet has a basis weight of 296 to 420 grams per square meter, and in some embodiments has a basis weight of 360 to 385 grams per square meter. In some embodiments the base sheet has a basis weight of 360 to 370 grams per square meter.

The base sheet has a maximum organic content of 1.5 weight percent, the percent organic content based solely on the weight of the base sheet. In some preferred embodiments, the base sheet has a maximum organic content of 1.0 weight percent, the percent organic content again based solely on the weight of the base sheet (i.e., the total weight of organic material plus glass). In some embodiments, the base sheet has a Gross Heat of Combustion (PCS) of less than 0.38 M J/kg, as measured per EN ISO 1716. In some other embodiments, the base sheet has a Gross Heat of Combustion (PCS) of less than 0.25M J/kg, as measured per EN ISO 1716. It is believed the base sheet having a low organic content can be made by either controlling the amount of organic material (such as the amount of binder and/or fiber finish) used in the manufacture of the base sheet, or by scouring or removing organic matter from the base sheet after manufacture by chemical or thermal processes, or by some combination of both of these techniques.

The fire-retardant membrane comprises a layer of a thermoplastic elastomer film attached to the base sheet. The layer of thermoplastic elastomer film provides the desired waterproofing to the sheet while also providing adequate water vapor permeability. Specifically, the film is preferably a monolithic film layer, and the thermoplastic elastomer is a hydrophilic material. The monolithic thermoplastic elastomer film layer is therefore hydrophilic, meaning it can transfer substantial amounts of water vapor through the film by absorbing water on one side of the film where the water concentration is high, and desorbing or evaporating it on another side where the water concentration is lower. Hydrophilic is defined as having a contact angle ranging between 0 and 90 degrees as determined by ASTM D5946-17. By “monolithic” it is meant the film is not a microporous film and has no continuous pores through the thickness. Thermoplastic elastomers are designated by ISO 18064:2022 into six generic classes. Three of these classes can be sufficiently hydrophilic to function as the water vapor permeable layer. Those classes are Thermoplastic polyurethane (TPU), Thermoplastic copolyester (TPE-E), and thermoplastic polyamide (TPE-A).

The thermoplastic elastomer film attached to the base sheet has a basis weight of 20 to 35 grams per square meter. In some embodiments, the thermoplastic elastomer film has a basis weight of 25 to 31 grams per square meter. In some embodiments, the thermoplastic elastomer film has a thickness of 18 to 31 micrometers. In some preferred embodiments, the thermoplastic elastomer film has a thickness of 22 to 28 micrometers.

In some embodiments, the thermoplastic elastomer film can comprise a TPC-E elastomer; TPC-E elastomers contain hard crystalline polyester blocks and long-chain soft amorphous polyether blocks. Examples of TPC-E materials are products sold under the Hytrel® brand. In some embodiments, the thermoplastic elastomer film can comprise a TPE-A elastomer. TPE-A elastomers contain polyamide hard blocks with polyether soft amorphous blocks. Examples of TPE-A materials are products sold under the PEBAX® and VESTAMID® E brands.

In some embodiments, the thermoplastic elastomer film is a TPU elastomer. TPU elastomers comprise aromatic polyurethane polymer based on linear segmented block copolymers composed of hard and soft segments, utilizing diisocyanates reacted with polyester or polyether diols. Examples of TPU materials are products sold under the brandnames of Platilon®, Pellethane®, and Estane®. A preferred TPU embodiment is Platilon® U.

It has been found that microporous films are less desirable for providing permanent waterproofing to the base sheet in the breather membrane. By microporous films, it is meant an extruded or cast film or coating that has pores sized to permit vapor molecules to pass while blocking liquid water drops and can have had its surface energy modified to reduce its ability to wet out. These microporous films are less desirable for use as a façade material because any surfactants used in cleaning the exterior of the building can modify the surface energy of the microporous film, allowing it to wet out and not provide the desired level of continuous waterproofing.

The thermoplastic elastomer film is attached to the base sheet by an adhesive. The adhesive is discontinuously present between the base sheet and the film; that is, the adhesive does not continuously cover either the surface of the base sheet or the film, nor does the adhesive form a continuous layer between the base sheet or the film. The lack of a continuous adhesive layer allows the breather membrane to “breathe”, allowing moisture vapor to move through the breather membrane between the adhesive tie points. The adhesive can be applied discontinuously to one or both of the base sheet or the film layer using a suitable technique such as direct gravure printing that provides individual domains of adhesive on the surface of the base sheet and/or the film. These domains create tie or bond points between the base sheet and the film. The discontinuous adhesive may be applied in any desired pattern, e.g., lines, dots, polygons, or other shapes. Some suitable methods for applying an adhesive in a discontinuous pattern and attaching sheet materials are described, for example, in U.S. Pat. Nos. 5,874,140; 5,531,419; 7,55,377; and U.S. Pat. Pub. U.S. Pat. No. 20,050,130521A1, all to Wyner, et al.

Just as it has been found that microporous films are not suitable for use in the breather membrane, it has also been found that films extruded directly onto the surface of the base sheet are not suitable in the breather membrane. Such directly-extruded films suffer from pinholes, which affects water holdout performance. It is believed these pinholes are due to the surface characteristics of the base sheet comprising glass fiber, which can have a random glass filament sticking out from the sheet that can penetrate the extruded film, which by necessity is quite thin. Therefore, it has been found that discontinuously-adhering a monolithic film to the base sheet tends to mitigate any issues associated with surface roughness of the base sheet, as the surface of the monolithic film layer is discontinuously bound to the surface of the base sheet, unlike a direct-extruded film.

The adhesive is discontinuously present between the film and the sheet at an areal density of 25 to 40%, and the adhesive is present in an amount of from 4 to 6 grams per square meter. In some embodiments, the adhesive is discontinuously present between the film and the sheet at an areal density of 30 to 35%. In preferred embodiments, the adhesive is discontinuously present as uniformly-applied domains or round dots of adhesive between the film and the base sheet. In some embodiments, the adhesive is a polyurethane. Alternative adhesives could include epoxies and hot melts.

In preferred embodiments, the fire-retardant membrane consists of two layers. The term “layer” as used herein refers to a discrete region of material that is free-standing in the form of a film or other sheet material. Therefore, the array of adhesive between the layers is not considered a layer herein.

The adhesively-attached two-layer fire-retardant membrane has a Gross Heat of Combustion (PCS) of less than 3 MJ/kg and less than 4 MJ/sqm as measured per EN ISO 1716, and preferably has a Euroclass A2 fire rating per EN 13501-1.

In some embodiments, the fire-retardant membrane has a water vapor diffusion equivalent air layer thickness (Sd value) of less than 0.12 meters as measured by EN ISO 12572. In some other embodiments, the fire-retardant membrane has a water vapor diffusion equivalent air layer thickness (Sd value) of less than 0.1 meter as measured by EN ISO 12572. The Sd value is a measure of how much resistance to moisture diffusion the membrane has, expressed as the equivalent air layer thickness. The unit of measurement is meters.

In some embodiments, the fire-retardant membrane shows no evidence of water penetration after exposure to a water column of 200 mm for 2 hours per EN 1928 (method A). This is equivalent to a Class W1 water tightness classification, which requires zero water leakage at 200 mm per the test method.

In some embodiments, the fire-retardant membrane, after UV aging of at least 5000 hours at 50° C. corresponding to 800 MJ/m2 per EN 1297 shows no evidence of water penetration after exposure to a water column of 200 mm for 2 hours per EN 1928 (method A). Again, this is equivalent to a Class W1 water tightness classification.

The fire-retardant membrane is useful as a material layer in a façade or wall system, particularly a material layer near or at the exterior of the wall, preferably between exterior cladding and the wall support structure. Preferably, the material layer of fire-retardant membrane is made from sections of individual layers of the fire-retardant membrane that cover the wall, and that further overlap at the edges. This type of arrangement of individual layers of fire-retardant membrane is considered herein to be a plurality of “layered sections” of the fire-retardant membrane. Preferably, an edge of a first layered section of the fire-retardant membrane overlaps a second layered section of the fire-retardant membrane by at least 100 mm.

In some embodiments, the layered sections of the fire-retardant membrane are further sealed with a fire-retardant tape, and in some embodiments that tape has having a Gross Heat of Combustion (PCS) of less than 7.4 MJ/kg and less than 1.6 MJ/sqm as measured per EN ISO 1716. Additionally, in some embodiments the total the areal surface coverage of the tape on the façade or wall system is 5.4 percent or less, based on the areal coverage on the wall structure of the material layer comprising the fire-retardant membrane.

In some embodiments the façade or wall system has an exterior surface and an interior surface, and the façade or wall system can further comprise a plurality of layered sections of a vapor barrier membrane located closer to the interior surface of the wall structure than the layered sections of the fire-retardant membrane. This vapor-barrier membrane can also be sealed with a tape. In preferred embodiments, an edge of a first layered section of vapor-barrier membrane overlaps a second layered section of the vapor-barrier membrane at least 100 mm. In some embodiments, the vapor-barrier membrane has a Gross Heat of Combustion (PCS) of less than 0.51 MJ/kg and less than 0.1 MJ/sqm. In some embodiments, the total the areal surface coverage of the tape on the vapor-barrier membrane is 5.4 percent or less.

### Test Methods

EN ISO 1716:2018 is the heat of combustion test that determines the potential maximum total heat release of a product when completely burned, regardless of its end use. The test is also relevant for the classes A1 and A2, and their subclasses. This test is used to determine of both the gross heat of combustion (PCS) and the net heat of combustion (PCI).

EN ISO 13823:2020 is the reaction to fire tests for building products; the building products excluding floorings exposed to the thermal attack by a single burning item. This European Standard specifies a method of test for determining the reaction to fire performance of construction products excluding floorings, when exposed to thermal attack by a single burning item (SBI).

Thermoplastic elastomer film thickness was determined by ASTM D6988-21.

### EXAMPLE

A fire-retardant and weather-resistant barrier laminate was produced as follows. The base sheet was a E/ECR (E-Glass Corrosion Resistant) glass mat that is a plain weave fabric having leno weft threads and having a basis weight of about 362 gsm and an organic content of 1.0 weight percent (ash/glass content 99.0 weight percent) as determined by TGA in accordance with ASTM E1131-20. The base sheet further had a gross heat of combustion (PCS) value of 0.234 MJ/kg per EN ISO 1716. A thermoplastic polyurethane (TPU) film (Platilon® U) having a basis weight of 28 gsm was then attached to the glass mat using a polyurethane (PU) adhesive that was applied using a discontinuous point bonding method. Specifically, the PU adhesive was a one-component reactive hot melt adhesive and was applied as discontinuous domains in a uniformly applied dot pattern in an amount of about 5 gsm with an areal density adhesive coverage of the base sheet of 35%, leaving about 65% percent of the area between the base sheet and the film unattached. The attachment or lamination of the film to the base sheet was performed using a set of nipped rolls after the adhesive was applied; the adhesive was then allowed to cure. The final fire-retardant and weather-resistant barrier laminate had a width of 1.5 m, a basis weight of 395 gsm, and a gross heat of combustion (PCS) value of 2.839 MJ/kg and 1.127 MJ/sqm per EN ISO 1716. Table 1 provides the testing and subsequent results found for the laminate. The version of any standard or method mentioned herein, unless otherwise provided herein, is the latest approved version as of the date of this application.

TABLE 1

| Property | Standard | Unit | Results |
|---|---|---|---|
| Weight per unit area | EN 1849-2 | g/m² | 392 |
| Tensile strength MD | EN 12311-1 | N/50 mm | 4430 |
| Elongat. at break MD | EN 12311-1 | % | 3 |
| Interlaminate adhesion | DIN 55543-5 | N | 3.85 |
| Waterproof passed* | EN 1928 | W1 | W1 |
| Hydrohead | EN 20811 | m | 304 |
| Sd-value | EN ISO 12572 | m | 0.080 ± 0.003 |
| MVTR | EN ISO 12572 | g/sqm*24 h | 267.4 |
| Tensile strength XD | EN 12311-1 | N/50 mm | 3706 |
| Elongat. at break XD | EN 12311-1 | % | 3 |

1. A fire-retardant membrane comprising:
a base sheet comprising glass fiber,
the base sheet having a basis weight of 296 to 420 grams per square meter,
the base sheet having a maximum organic content of 1.5 weight percent; and
a thermoplastic elastomer film attached to the base sheet, the film having a basis weight of 20 to 35 grams per square meter;
wherein the thermoplastic elastomer film is attached to the base sheet by use of an adhesive, the adhesive being discontinuously present between the film and the sheet at an areal density of 25 to 40% and the adhesive is present in an amount of from 4 to 6 grams per square meter; and
wherein the fire-retardant membrane has a Gross Heat of Combustion (PCS) of less than 3 MJ/kg and less than 4 MJ/sqm as measured per EN ISO 1716.

2. The fire-retardant membrane of claim 1 wherein the base sheet has a basis weight of 360 to 385 grams per square meter.

3. The fire-retardant membrane of claim 1 wherein the base sheet has a Gross Heat of Combustion (PCS) of less than 0.38 MJ/kg, as measured per EN ISO 1716.

4. The fire-retardant membrane of claim 1 wherein the base sheet is a plain weave glass fabric.

5. The fire-retardant membrane of claim 1 wherein the base sheet comprises E-glass.

6. The fire-retardant membrane of claim 1 wherein the thermoplastic elastomer film has a basis weight of 25 to 31 grams per square meter.

7. The fire-retardant membrane of claim 1 wherein the thermoplastic elastomer film comprises thermoplastic polyurethane (TPU), thermoplastic copolyester (TPE-E), thermoplastic polyamide (TPE-A), or mixtures thereof.

8. The fire-retardant membrane of claim 7 wherein the thermoplastic elastomer film comprises an aromatic polyurethane polymer based on polyester or polyether diols.

9. The fire-retardant membrane of claim 1 wherein the thermoplastic elastomer film is a monolithic film.

10. The fire-retardant membrane of claim 1 wherein the adhesive discontinuously present between the film and the sheet has an areal density of 30 to 35%.

11. The fire-retardant membrane of claim 1 wherein the adhesive is discontinuously present as dots of adhesive.

12. The fire-retardant membrane of claim 1 wherein the adhesive is a polyurethane.

13. The fire-retardant membrane of claim 1 having a water vapor diffusion equivalent air thickness (Sd value) of less than 0.12 as measured by EN ISO 12572.

14. The fire-retardant membrane of claim 1, wherein the fire-retardant membrane shows no evidence of water penetration after exposure to a water column of 200 mm for 2 hours per EN 1928 (method A).

15. The fire-retardant membrane of claim 1, wherein the fire-retardant membrane, after UV aging of at least 5000 hours at 50° C. corresponding to 800 MJ/m² per EN 1297, shows no evidence of water penetration after exposure to a water column of 200 mm for 2 hours per EN 1928 (method A).

16. The fire-retardant membrane of claim 1 having a Euroclass A2 fire rating per EN 13501-1.

17. A façade or wall system comprising a plurality of layered sections of the fire-retardant membrane of any one of claims 1 to 16 sealed with a tape having a Gross Heat of Combustion (PCS) of less than 7.4 MJ/kg and less than 1.6 MJ/sqm as measured per EN ISO 1716,
wherein an edge of a first layered section of the fire-retardant membrane overlaps a second layered section of the fire-retardant membrane at least 100 mm, and
wherein the total the areal surface coverage of the tape on the façade or wall system is 5.4 percent or less.

18. The façade or wall system of claim 17 further comprising a plurality of layered sections of a vapor-barrier membrane also sealed with a tape,
wherein an edge of a first layered section of vapor-barrier membrane overlaps a second layered section of the vapor-barrier membrane at least 100 mm, and
wherein the façade or wall system has an exterior surface and an interior surface, and
the layered sections of a vapor barrier membrane are located closer to the interior surface than the layered sections of the fire-retardant membrane.

19. The façade or wall system of claim 18, wherein the vapor-barrier membrane has a Gross Heat of Combustion (PCS) of less than 0.51 MJ/kg and less than 0.1 MJ/sqm, and
wherein the total the areal surface coverage of the tape on the vapor-barrier membrane is 5.4 percent or less.
